(19) United States
(12) Patent Application Publication
(10) Pub. No.: US 2022/0037642 A1
(43) Pub. Date: Feb. 3, 2022

(54) FORMULATION AND FABRICATION OF THICK CATHODES

(71) Applicant: GM GLOBAL TECHNOLOGY OPERATIONS LLC, Detroit, MI (US)

(72) Inventors: Nicole ELLISON, Madison Heights, MI (US); Xiaosong HUANG, Novi, MI (US)

(73) Assignee: GM GLOBAL TECHNOLOGY OPERATIONS LLC, Detroit, MI (US)

(21) Appl. No.: 16/943,661

(22) Filed: Jul. 30, 2020

(51) Int. Cl. H01M 4/139; H01M 10/0525; H01M 4/62; H01M 4/04

(52) U.S. Cl. CPC H01M 4/139; H01M 10/0525; H01M 4/625; H01M 2004/028; H01M 4/0404; H01M 4/0471; H01M 4/0435; H01M 4/622

(57) ABSTRACT

Thick positive electrodes (e.g., cathodes) for an electrochemical cell that cycles lithium and methods for making them are provided. A slurry may be applied to a current collector or other substrate. The slurry includes positive electroactive material particles, graphene nanoplatelets, polymeric binder, and solvent and has a solids content of ≥about 65% by weight and a kinematic viscosity of greater than or equal to about 6 Pa·s to less than or equal to about 30 Pa·s at a shear rate of about 20/s. The slurry is dried to substantially remove the solvent and pressure applied to form an electroactive material layer having a thickness of ≥about 150 μm and a porosity of ≥about 15% by volume to ≤about 50% by volume. The electroactive material layer is substantially free of macrocracks.

### INTRODUCTION

This section provides background information related to the present disclosure which is not necessarily prior art.

High-energy density, electrochemical cells, such as lithium-ion batteries can be used in a variety of consumer products and vehicles, such as Hybrid Electric Vehicles (HEVs) and Electric Vehicles (EVs). Typical lithium-ion and lithium-sulfur batteries include a first electrode, a second electrode, an electrolyte material, and a separator. One electrode serves as a positive electrode or cathode (on discharge) and another serves as a negative electrode or anode (on discharge). A stack of battery cells may be electrically connected to increase overall output. Conventional rechargeable lithium-ion batteries operate by reversibly passing lithium-ions back and forth between the negative electrode and the positive electrode. A separator and an electrolyte are disposed between the negative and positive electrodes. The electrolyte is suitable for conducting lithium-ions and may be in solid (e.g., solid-state diffusion) or liquid form. Lithium-ions move from a cathode (positive electrode) to an anode (negative electrode) during charging of the battery, and in the opposite direction when discharging the battery.

Positive electrodes or cathodes having a high loading density of positive electroactive materials are desirable to increase overall cell energy density. For example, thicker electroactive material layers and/or greater loading of electroactive materials increases a relative amount of positive electroactive materials relative to inert materials present in the electrochemical cell, such as current collectors and separators. Practically, however, positive electrode electroactive material layers have been limited to thicknesses of less than about 100 μm or so, due to difficulties in processing and applying slurries, along with cracking and other defects that often arise when thicker electrode materials are formed by slurry casting. For example, during slurry casting and fabrication, stress caused by volumetric shrinkage of the electrode slurry from drying leads to electrode fracture and delamination. Thus, many electroactive materials having thicknesses greater than 100 μm are observed to not only have macrocracking that is visible to an observer, but further are often observed to delaminate, easily separating or peeling from the current collector. Thus, electrochemical performance may be compromised by inferior liquid phase lithium ion transfer kinetics and the lack of structural integrity of thick electrodes, which deteriorate the life and power/fast charging performance.

Thus, it would be desirable to form electrochemical cells or batteries incorporating thick positive electrodes/cathode to provide higher energy density to increase storage capacity and/or reduce the size of the battery, while maintaining a similar cycle life as other lithium ion batteries.

### SUMMARY

This section provides a general summary of the disclosure, and is not a comprehensive disclosure of its full scope or all of its features.

In one variation, the present disclosure relates to a method of making a positive electrode for an electrochemical cell that cycles lithium. The method optionally includes applying a slurry to a current collector. The slurry includes a plurality of positive electroactive material particles, a plurality of graphene nanoplatelets, a polymeric binder, and solvent. The slurry may have a solids content of greater than or equal to about 65% by weight and a kinematic viscosity of greater than or equal to about 6 Pa·s to less than or equal to about 30 Pa·s at a shear rate of about 20/s. The method further includes drying the slurry to substantially remove the solvent and applying pressure to form an electroactive material layer having a thickness of greater than or equal to about 150 μm and a porosity of greater than or equal to 15% by volume to less than or equal to about 50% by volume. The electroactive material layer is substantially free of macrocracks.

In one aspect, the solids content of the slurry is greater than or equal to about 75% by weight.

In one aspect, the drying occurs at less than or equal to about 10 minutes.

In one aspect, the applying pressure is a consolidating or calendering process, where the current collector and the electroactive material layer is passed between rollers or platens.

In one aspect, the slurry has greater than or equal to about 30 weight % to less than or equal to about 36 weight % of solvent.

In one aspect, prior to the applying, the slurry is prepared by first mixing the plurality of graphene nanoplatelets and solvent together to form an admixture, followed by mixing the plurality of positive electroactive material particles and the polymeric binder into the admixture.

In one aspect, the mixing includes at least one mixing process selected from the group consisting of: resonance dispersion, sonic dispersion, ultrasonic dispersion, centrifugal or planetary mixing, rotary mixing, ball milling, and combinations thereof.

In one aspect, the slurry includes greater than or equal to about 80 weight % to less than or equal to about 98 weight % on a dry basis of the plurality of positive electroactive material particles, greater than or equal to about 0.5 weight % to less than or equal to about 15 weight % on a dry basis of the plurality of graphene nanoplatelets, greater than or equal to about 0.5 weight % to less than or equal to about 20 weight % on a dry basis of the polymeric binder and the slurry optionally further includes greater than 0 weight % to less than or equal to about 15 weight % on a dry basis of one or more optional filler components.

In one aspect, the polymeric binder is selected from the group consisting of: polyvinylidene difluoride (PVdF), lithium polyacrylate (LiPAA), sodium polyacrylate (NaPAA), polyacrylic acid, polytetrafluoroethylene (PTFE), polyethylene (PE), polyamide, polyimide, and combinations thereof.

In another variation, the present disclosure relates to a method of making a positive electrode for an electrochemical cell that cycles lithium. The method includes applying a slurry to a current collector. The slurry includes a plurality of positive electroactive material particles selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof present at greater than or equal to about 80% by weight of the total solids content in the slurry (on a dry basis excluding liquids/solvents). The slurry also includes a plurality of graphene nanoplatelets present at greater than or equal to about 0.5% by weight to less than or equal to about 15% by weight of the total solids in the slurry. The slurry further includes a polymeric binder present at greater than or equal to about 0.5% by weight to less than or equal to about 20% by weight of the total solids in the slurry, and solvent. The slurry may have a solids content of greater than or equal to about 70% by weight, and a kinematic viscosity of greater than or equal to about 6 Pa·s to less than or equal to about 30 Pa·s at a shear rate of about 20/s. The method also includes drying the slurry to substantially remove the solvent and applying pressure to form an electroactive material layer having a thickness of greater than or equal to about 150 μm and a porosity of greater than or equal to about 15% by volume to less than or equal to about 50% by volume, wherein the electroactive material layer is substantially free of macrocracks.

In one aspect, the drying occurs at less than or equal to about 10 minutes. The applying pressure is a consolidating or calendering process where the current collector and the electroactive material layer are passed between rollers or platens.

In one aspect, prior to the applying, the slurry is prepared by first mixing the plurality of graphene nanoplatelets and solvent together to form an admixture, followed by mixing the plurality of positive electroactive material particles and the polymeric binder into the admixture.

In one aspect, the mixing includes at least one mixing process selected from the group consisting of: resonance dispersion, sonic dispersion, ultrasonic dispersion, centrifugal or planetary mixing, rotary mixing, ball milling, and combinations thereof.

In one aspect, the slurry further includes greater than 0 weight % to less than or equal to about 15 weight % of one or more optional filler components.

In yet other variations, the present disclosure relates to a positive electrode for an electrochemical cell that cycles lithium. The positive electrode may include a current collector and an electroactive material layer. The electroactive material layer has a thickness of greater than or equal to about 150 μm, a porosity of greater than or equal to about 15% by volume to less than or equal to about 50% by volume. The electroactive material layer may include a positive electroactive material present at greater than or equal to about 80% by weight of the electroactive material layer, a plurality of graphene nanoplatelets having an aspect ratio of greater than or equal to about 20 present at greater than or equal to about 0.5% by weight to less than or equal to about 15% by weight of the electroactive material layer, and a polymeric binder. Further, the electroactive material layer is substantially free of macrocracks.

In one aspect, the electroactive material layer includes greater than or equal to about 80 weight % to less than or equal to about 98 weight % of the plurality of positive electroactive material particles, greater than or equal to about 0.5 weight % to less than or equal to about 15 weight % of the plurality of graphene nanoplatelets, and greater than or equal to about 0.5 weight % to less than or equal to about 20 weight % of the polymeric binder and optionally further includes less than or equal to about 15 weight % of one or more optional filler components including electrically conductive particles.

In one aspect, the electroactive material layer has a thickness of greater than or equal to about 175 μm to less than or equal to about 2,000 μm.

In one aspect, the positive electroactive material is selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof.

In one aspect, the positive electroactive material includes a coating selected from the group consisting of: a carbon-containing coating, an oxide-containing coating, a fluoride-containing coating, a nitride-containing coating, and combinations thereof.

In one aspect, the polymeric binder is selected from the group consisting of: polyvinylidene difluoride (PVdF), lithium polyacrylate (LiPAA), sodium polyacrylate (NaPAA), polyacrylic acid, polytetrafluoroethylene (PTFE), polyethylene (PE), polyamide, polyimide, and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell.

FIG. 2 is an illustration of a cross-sectional view of one variation of a positive electrode incorporating a plurality of positive electroactive material particles and graphene nanoplatelets in a porous polymeric binder matrix prepared in accordance with certain aspects of the present disclosure.

FIG. 3 is an illustration of a graphene nanoplatelet used to form a positive electrode in accordance with certain aspects of the present disclosure.

FIG. 4 is an illustration of a cross-sectional view of another variation of a positive electrode incorporating a plurality of positive electroactive material particles, graphene nanoplatelets, and conductive particles in a porous polymeric binder matrix prepared in accordance with certain aspects of the present disclosure.

FIG. 5 is a scanning electron microscopy (SEM) image showing a cross-sectional view of a positive electrode incorporating a plurality of positive electroactive material particles and graphene nanoplatelets in a porous polymeric binder matrix having a thickness of about 200 μm (scale bar 50 μm) without visible macrocrack formation prepared in accordance with certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure provides methods of making high-quality thick electrodes (and electrochemical cells including the improved thick electrodes). In particular, the present disclosure provides methods of making high-quality thick positive electrodes that are free of significant structural defects, such as macrocracks. In particular, the methods contemplate slurry casting a precursor slurry having a high solids content and relatively low amount of solvent onto a current collector to form a high quality electrode layer having a thickness of greater than about 150 μm. The present disclosure also contemplates thick positive electrodes and electrochemical cells incorporating such positive electrode materials.

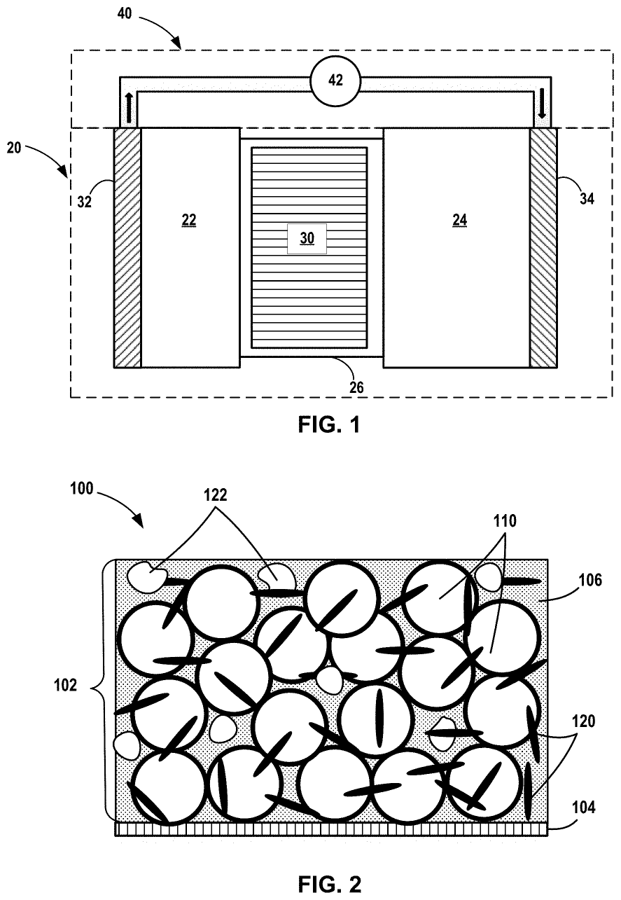

By way of background, an exemplary and schematic illustration of an electrochemical cell (also referred to as a battery) 20 is shown in FIG. 1. Although the illustrated examples include a single positive electrode or cathode and a single negative electrode or anode, the skilled artisan will recognize that the present disclosure also contemplates various other configurations, including those having one or more cathodes and one or more anodes, as well as various current collectors with electroactive layers disposed on or adjacent to one or more surfaces thereof.

A typical lithium-ion battery 20 includes a first electrode (such as a negative electrode 22 or anode) opposing a second electrode (such as a positive electrode 24 or cathode) and a separator 26 and/or electrolyte 30 disposed therebetween. While not shown, often in a lithium-ion battery pack, batteries or cells may be electrically connected in a stack or winding configuration to increase overall output. Lithium-ion batteries operate by reversibly passing lithium ions between the first and second electrodes. For example, lithium ions may move from the positive electrode 24 to the negative electrode 22 during charging of the battery, and in the opposite direction when discharging the battery. The electrolyte 30 is suitable for conducting lithium ions and may be in liquid, gel, or solid form.

The separator 26 (e.g., a microporous polymeric separator) is thus disposed between the two electrodes 22, 24 and may comprise the electrolyte 30, which may also be present in the pores of the negative electrode 22 and positive electrode 24. A negative electrode current collector 32 may be positioned at or near the negative electrode 22 and a positive electrode current collector 34 may be positioned at or near the positive electrode 24. An interruptible external circuit 40 and a load device 42 connects the negative electrode 22 (through its current collector 32) and the positive electrode 24 (through its current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte solution 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, the separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. The negative electrode current collector 32 and positive electrode current collector 34 respectively collect and move free electrons to and from an external circuit 40.

Further, the separator 26 operates as an electrical insulator by being sandwiched between the negative electrode 22 and the positive electrode 24 to prevent physical contact and thus, the occurrence of a short circuit. The separator 26 provides not only a physical and electrical barrier between the two electrodes 22, 24, but also contains the electrolyte solution in a network of open pores during the cycling of lithium ions, to facilitate functioning of the battery 20.

The battery 20 can include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

The present technology pertains to improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran, 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (SSE) (not shown) that functions as both an electrolyte and a separator. The SSE may be disposed between the positive electrode 24 and negative electrode 22. The SSE facilitates transfer of lithium ions, while mechanically separating and providing electrical insulation between the negative and positive electrodes 22, 24. By way of non-limiting example, SSEs may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof.

The negative electrode 22 includes an electroactive material this is a lithium host material capable of functioning as a negative terminal of a lithium ion battery. The negative electrode 22 may be formed from a lithium host material that is capable of functioning as a negative terminal of a lithium-ion battery. The negative electrode 22 may be a layer of the negative electroactive material or may be a porous electrode composite and include the negative electrode active material and, optionally, an electrically conductive material or other filler, as well as one or more polymeric binder materials to structurally hold the lithium host electroactive material particles together.

In certain variations, the negative electrode active material may comprise lithium, such as, for example, lithium metal. In certain variations, the negative electrode 22 is a film or layer formed of lithium metal or an alloy of lithium. Other materials can also be used to form the negative electrode 22, including, for example, graphite, lithium-silicon and silicon containing binary and ternary alloys and/or tin-containing alloys, such as Si—Sn, SiSnFe, SiSnAl, SiFeCo, SnO₂, and the like. In certain alternative embodiments, lithium-titanium anode materials are contemplated, such as Li₄₊ₓTi₅O₁₂, where 0≤x≤3, including lithium titanate (Li₄Ti₅O₁₂) (LTO). Thus, negative electroactive materials for the negative electrode 22 may be selected from the group consisting of: lithium, graphite, silicon, silicon-containing alloys, tin-containing alloys, and combinations thereof.

Such negative electrode active materials may be optionally intermingled with an electrically conductive material that provides an electron conduction path and/or at least one polymeric binder material that improves the structural integrity of the negative electrode 22. By way of non-limiting example, the negative electrode 22 may include an active material including electroactive material particles (e.g., graphite particles) intermingled with a polymeric binder material. The polymeric binder material may be selected from the group consisting of polyvinylidene fluoride (PVDF), polytetrafluoroethylene (PTFE), ethylene propylene diene monomer (EPDM) rubber, carboxymethoxyl cellulose (CMC), nitrile butadiene rubber (NBR), lithium polyacrylate (LiPAA), sodium polyacrylate (NaPAA), polyacrylic acid, polytetrafluoroethylene (PTFE), polyethylene (PE), polyamide, polyimide, sodium alginate, lithium alginate, and combinations thereof, by way of example.

Additional suitable electrically conductive materials may include carbon-based materials or a conductive polymer. Carbon-based materials may include, by way of non-limiting example, particles of KETCHEN™ black, DENKA™ black, acetylene black, carbon black, graphene, carbon nanotubes, carbon nanofibers, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of conductive materials may be used.

A composite negative electrode may comprise the negative electrode active material present at greater than about 60 wt. % of the overall weight of the electroactive material of the electrode (not including the weight of the current collector), optionally greater than or equal to about 65 wt. %, optionally greater than or equal to about 70 wt. %, optionally greater than or equal to about 75 wt. %, optionally greater than or equal to about 80 wt. %, optionally greater than or equal to about 85 wt. %, optionally greater than or equal to about 90 wt. %, and in certain variations, optionally greater than or equal to about 95% of the overall weight of the electroactive material layer of the electrode.

The binder may be present in the negative electrode 22 at greater than or equal to about 1 wt. % to less than or equal to about 20 wt. %, optionally greater than or equal to about 1 wt. % to less than or equal to about 10 wt. %, optionally greater than or equal to about 1 wt. % to less than or equal to about 8 wt. %, optionally greater than or equal to about 1 wt. % to less than or equal to about 7 wt. %, optionally greater than or equal to about 1 wt. % to less than or equal to about 6 wt. %, optionally greater than or equal to about 1 wt. % to less than or equal to about 5 wt. %, or optionally greater than or equal to about 1 wt. % to less than or equal to about 3 wt. % of the total weight of the electroactive material layer of the electrode.

In certain variations, the negative electrode 22 includes the electrically-conductive material at less than or equal to about 20 wt. %, optionally less than or equal to about 15 wt. %, optionally less than or equal to about 10 wt. %, optionally less than or equal to about 5 wt. %, optionally less than or equal to about 1 wt. %, or optionally greater than or equal to about 0.5 wt. % to less than or equal to about 8 wt. % of the total weight of the electroactive material layer of the negative electrode. While the electrically conductive materials may be described as powders, these materials can lose their powder-like character following incorporation into the electrode, where the associated particles of the supplemental electrically conductive materials become a component of the resulting electrode structure.

The negative electrode current collector 32 can comprise metal, for example, it may be formed from copper (Cu), nickel (Ni), or alloys thereof or any other appropriate electrically conductive material known to those of skill in the art.

In certain aspects, the negative electrode current collector 32 and/or positive electrode current collector (discussed below) may be in the form of a foil, slit mesh, expanded metal a metal grid or screen, and/or woven mesh. Expanded metal current collectors refer to metal grids with a greater thickness such that a greater amount of electrode active material is placed within the metal grid.

The present disclosure contemplates forming thick positive electrodes 24. By a thick electrode, it is meant that the positive electrode 24 (the electroactive material layer, excluding the current collector 34) has a thickness of greater than or equal to about 125 μm, optionally greater than or equal to about 150 μm, optionally greater than or equal to about 175 μm, optionally greater than or equal to about 200 μm, optionally greater than or equal to about 225 μm, optionally greater than or equal to about 250 μm, optionally greater than or equal to about 275 μm, and in certain variations, optionally greater than or equal to about 300 μm. In certain variations, a thickness of the positive electrode 24 may be greater than or equal to about 150 μm to less than or equal to about 2,000 μm, optionally greater than or equal to about 150 μm to less than or equal to about 1,000 μm. In certain variations, the thickness of the positive electrode 24 may be greater than or equal to about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1,000 μm, about 1,250 μm, about 1,500 μm, or about 1,750 μm.

FIG. 2 shows a positive electrode 100 formed in accordance with certain aspects of the present disclosure having a thickness of at least about 150 μm. The thick positive electrodes 100 formed in accordance with certain aspects of the present disclosure may be porous, composite electrodes. The thick positive electrode 100 may define an electroactive material layer 102 disposed on a current collector 104. The electroactive material layer 102 may include a plurality of particles of the positive electroactive material 110. In certain variations, the positive electroactive materials 110 may be intermingled with an electronically conducting material that provides an electron conduction path and/or at least one polymeric binder material that improves the structural integrity of the electrode. Thus, the electroactive material layer 102 further includes a plurality of electrically conductive particles in the form of a plurality of graphene nanoplatelets 120 and a polymeric binder 106. The polymeric binder 106 serves as a matrix in which the solid particles (positive electroactive material 110 and graphene nanoplatelets 120) are distributed.

In various aspects, the positive electroactive material 110 may be formed from a lithium-based electroactive material that can sufficiently undergo lithium intercalation and deintercalation, or alloying and dealloying, while functioning as the positive terminal of the battery. One exemplary common class of known materials that can be used to form the electroactive material layer 102 of the positive electrode 100 is layered lithium transitional metal oxides. For example, in certain aspects, the electroactive material layer 102 of the positive electrode 100 may comprise one or more materials having a spinel structure, such as lithium manganese oxide (Li₍₁₊ₓ₎Mn₂O₄, where 0.1≤x≤1, abbreviated LMO), lithium manganese nickel oxide (LiMn₍₂₋ₓ₎NiₓO₄, where 0≤x≤0.5, abbreviated LMNO) (e.g., LiMn_{1.5}Ni_{0.5}O₄), a lithium iron polyanion oxide with olivine structure, such as lithium iron phosphate (LiFePO₄, abbreviated LFP), or other phosphate based actives, like lithium manganese-iron phosphate (LiMn₂₋ₓFeₓPO₄, where 0<x<0.3, abbreviated LMFP), lithium iron fluorophosphate (Li₂FePO₄F), one or more materials with a layered structure, such as lithium cobalt oxide (LiCoO₂), lithium nickel manganese cobalt oxide (Li(NiₓMn_{y}Coz)O₂, where 0≤x≤1, 0≤y≤1, 0≤z≤1, and x+y+z=1, abbreviated NMC) (e.g., LiMn_{0.33}Ni_{0.33}Co_{0.33}O₂), a lithium nickel manganese cobalt aluminum oxide, such as Li(Ni_{0.89}Mn_{0.05}Co_{0.05}Al_{0.01})O₂ (abbreviated NCMA), a lithium nickel cobalt metal oxide (LiNi_{(1-x-y)}CoₓM_{y}O₂, where 0<x<0.2, y<0.2, and M may be Al, Mg, Ti, or the like), or lithium silicate based materials, like orthosilicates, Li₂MSiO₄ (where M=Mn, Fe, and Co) or silicides, like Li₆MnSi₅, and any combinations thereof.

In certain variations, the positive electroactive materials 110 may be doped (for example, by magnesium (Mg)) or have a coating disposed over each particle surface. For example, the coating may be a carbon-containing, oxide-containing (e.g., aluminum oxide), fluoride-containing, nitride-containing or polymeric thin coating disposed over the electroactive material. The coating may be ionically conductive and optionally electrically conductive. The coating may also be applied over the composite electrode (electroactive material layer 102) after formation in alternative variations.

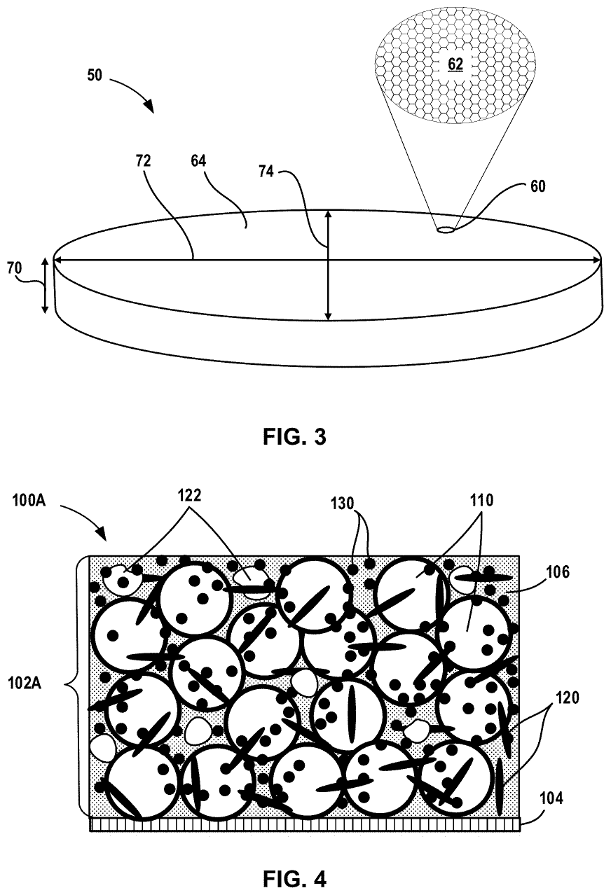

FIG. 3 shows an illustration of an example of one such graphene nanoplatelet 50 (like the plurality of graphene nanoplatelets 120 shown in FIG. 2). The graphene nanoplatelet 50 is formed from at least one sheet of graphene. For example, the graphene nanoplatelet 50 may comprise stacks of graphene sheets having a platelet or planar shape. A hexagonal lattice 62 of carbon atoms forming graphene is shown in the detailed region 60 of surface 64 of the graphene nanoplatelet 50. Each sheet within the graphene nanoplatelet 50 is formed of the two-dimensional hexagonal lattice 62. Each graphene nanoplatelet 50 may have a structure with a height 70, and a major elongate dimension (like length 72), and a second elongate dimension (like width 74). In certain aspects, the nanoplatelets 50 of the present disclosure have high aspect ratios with regard to length to height (or width to height), so that a platelet or planar microparticle shape is formed. For example, an aspect ratio may be defined as AR=H/L, where H and L are the height and the length (or alternatively width) of the nanoparticle. An AR of the nanoplatelets 50 may be greater than or equal to about 2, optionally greater than or equal to about 5, optionally greater than or equal to about 10, optionally greater than or equal to about 15, optionally greater than or equal to about 20, optionally greater than or equal to about 25, optionally greater than or equal to about 50, and in certain aspects, optionally greater than or equal to about 100.

In certain variations, the height 70 may be greater than or equal to about 5 nm to less than or equal to about 5 μm; optionally greater than or equal to about 10 nm to less than or equal to about 1 μm; optionally greater than or equal to about 10 nm to less than or equal to about 0.5 μm, and in certain aspects, optionally greater than or equal to about 10 nm to less than or equal to about 100 nm. The major dimension or length 72 may be greater than or equal to about 15 nm to less than or equal to about 100 μm; optionally greater than or equal to about 20 nm to less than or equal to about 10 μm; and in certain aspects, optionally greater than or equal to about 20 nm to less than or equal to about 1 In one variation, the particle height 70 may be less than or equal to about 100 nm, while the major dimension or length 72 may be greater than or equal to about 2 μm to less than or equal to about 25 μm.

In certain aspects, the nanoplatelets 50 advantageously provide a lower surface area than other traditional conductive particles, such as spherical or fibrous/tubular particles. Moreover, it is believed that the nanoplatelets 50 have a surface chemistry that provides an enhanced wettability of the various components in the slurry as compared to traditional conductive particles, like carbon black. In this manner, as will be described further below, the graphene nanoplatelets provide for optimal slurry dispersion and viscosity levels that enable the formation of thick electrodes having complex mechanical and electrical networks within the electrode for enhanced performance.

With renewed reference to FIG. 2, the positive electroactive materials 110 may be powder compositions. The positive electroactive material particles 110 and graphene nanoplatelets 120 may be intermingled with the polymeric binder 106.

The binder 106 may both hold together the positive electroactive material 110 and provide ionic conductivity to the electroactive material layer 102 of the positive electrode 100. The electroactive material layer 102 may be slurry cast with polymeric binders, like polyvinylidene difluoride (PVdF), lithium polyacrylate (LiPAA), sodium polyacrylate (NaPAA), polyacrylic acid, polyethylene (PE), polyamide, polyimide, polytetrafluoroethylene (PTFE), ethylene propylene diene monomer (EPDM) rubber, carboxymethyl cellulose (CMC), a nitrile butadiene rubber (NBR), styrene-butadiene rubber (SBR), poly(vinylidene chloride) (PVC), poly((dichloro-1,4-phenylene)ethylene), fluorinated urethanes, epoxides, fluorinated epoxides, fluorinated acrylics, copolymers of halogenated hydrocarbon polymers, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, sodium alginate, lithium alginate, or combinations thereof. In certain variations, the polymeric binder may include one or more of the following: polyvinylidene difluoride (PVdF) and polyacrylate binders, such as lithium polyacrylate (LiPAA), sodium polyacrylate (NaPAA) polyacrylic acid, or polytetrafluoroethylene (PTFE), polyethylene (PE), polyamide, and/or polyimide.

The electroactive material layer 102 may further comprise a plurality of pores 122 distributed within the polymeric binder 106. A porosity of the electroactive material layer 102 after all processing is completed (including consolidation and calendering) may considered to be a fraction of void volume defined by pores over the total volume of the electroactive material layer 102. The porosity may be greater than or equal to about 15% by volume to less than or equal to about 50% by volume, optionally greater than or equal to 20% by volume to less than or equal to about 40% by volume, and in certain variations, optionally greater than or equal to 25% by volume to less than or equal to about 35% by volume.

FIG. 4 shows an alternative variation of a positive electrode 100A like that in FIG. 2. To the extent that the components are the same in the positive electrode 100 of FIG. 2 and positive electrode 100A in FIG. 4, they share the same numbering and for brevity will not be introduced again unless specifically discussed herein. The positive electrode 100A includes an electroactive material layer 102A that includes the plurality of particles of the positive electroactive material 110, the plurality of graphene nanoplatelets 120, and the polymeric binder 106. However, the electroactive material layer 102A may also further comprise additional filler components, such as supplemental electronically or electrically conductive materials 130 in addition to the graphene nanoplatelets 120. Such additional electrically conductive materials 130 may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, and the like. Examples of a conductive polymer include polyaniline, polythiophene, polyacetylene, polypyrrole, and the like. In certain aspects, mixtures of the electrically conductive materials 130 (in addition to the graphene nanoplatelets 120) may be used.

In accordance with certain aspects of the present disclosure, an electroactive material layer of the positive electrode may comprise the positive electroactive material particles at greater than about 80 wt. % of the overall weight of the positive electroactive material layer, optionally greater than or equal to about 85 wt. %, optionally greater than or equal to about 90 wt. %, optionally greater than or equal to about 95 wt. %, optionally greater than or equal to about 97 wt. %, and in certain variations, optionally greater than or equal to about 98% of the overall weight of the positive electroactive material layer. In certain variations, the positive electroactive material may be present in the electroactive material layer of the positive electrode at greater than or equal to about 80 wt. % to less than or equal to about 98 wt. %.

The positive electrodes can have a positive electroactive material particle loading on each side of the current collector from 20 mg/cm² to 100 mg/cm². A person of ordinary skill in the art can recognize that additional ranges of electroactive material loading within the explicit range above are contemplated and are within the present disclosure.

The polymeric binder may be present in the electroactive material layer of the positive electrode at greater than or equal to about 0.5 wt. % to less than or equal to about 20 wt. %, optionally greater than or equal to about 1 wt. % to less than or equal to about 15 wt. %, optionally greater than or equal to about 1 wt. % to less than or equal to about 10 wt. %, optionally greater than or equal to about 1 wt. % to less than or equal to about 8 wt. %, or optionally greater than or equal to about 1 wt. % to less than or equal to about 5 wt. % of the total weight of the electroactive material layer of the electrode.

In certain variations, the electroactive material layer of the positive electrode comprises the graphene nanoplatelets at greater than or equal to about 0.1 wt. % to less than or equal to about 15 wt. %, optionally greater than or equal to about 0.5 wt. % to less than or equal to about 15 wt. %, optionally greater than or equal to about 1 wt. % to less than or equal to about 13 wt. %, optionally greater than or equal to about 1 wt. % to less than or equal to about 10 wt. %, optionally greater than or equal to about 1 wt. % to less than or equal to about 7 wt. %, or optionally greater than or equal to about 1 wt. % to less than or equal to about 5 wt. % of the total weight of the electroactive material layer of the electrode.

In certain variations, where the positive electrode includes additional components, such as additional electrically-conductive materials, they are cumulatively present at less than or equal to about 15 wt. %, optionally less than or equal to about 10 wt. %, optionally less than or equal to about 5 wt. %, optionally less than or equal to about 3 wt. %, or optionally less than or equal to about 1 wt. % of the electroactive material layer of the positive electrode.

The positive electrode current collector (104 in FIGS. 2 and 4) may be formed from aluminum (Al) or any other appropriate electrically conductive material known to those of skill in the art.

While the present disclosure primarily pertains to positive electrodes, it will be appreciated that in alternative aspects, the present disclosure also contemplates forming negative electrodes with composite electroactive material layers with negative electroactive materials that further incorporate graphene nanoplatelets and a polymeric binder.

In various aspects, the present disclosure contemplates methods of making thick porous composite electrodes in a process that results in a final product that is substantially free of significant defects or mechanical issues that typically otherwise arise when trying to form thick composite electrodes. In one aspect, a method of making a positive electrode for an electrochemical cell that cycles lithium is provided that comprises applying a slurry to a current collector. Slurries can be coated onto one side or both sides of the current collector. The slurry comprises a plurality of positive electroactive material particles, a plurality of graphene nanoplatelets, a polymeric binder, and solvent. The slurry may also comprise an optional plasticizer, in alternative variations. The solvent may include water, an alcohol, N-methyl-2-pyrrolidone (NMP), dimethyl sulfoxide (DMSO), dimethylformamide (DMF), dimethylacetamide (DMAc), or combinations thereof, by way of non-limiting example.

In various aspects, the slurry used in accordance with the present disclosure has a relatively high solids content compared to what could be achieved with conventional processes. The ability to have a higher solids content is believed to be attributable to the presence of the graphene nanoplatelets in the slurry. For example, the graphene nanoplatelets have a shape with a relatively low surface area that facilitates better dispersion of the particles within the slurry. It has been observed that the use of graphene nanoplatelets enables a higher initial slurry solids content than with the use of carbon black alone, enabling a more stable wet slurry network during coating and decreased drying time for forming the electrode. Thus, the uniformity of the slurry and dispersion of solid particles is enhanced, resulting in improved electrode quality at greater thicknesses. Moreover, viscosity for the same solids content as standard carbon black is lower with graphene nanoplatelets, enabling easier processing and a higher quality electrode. When using select polymeric binders, such as PAA binders, it was surprisingly observed that the solids content of the slurry could be further increased. While relatively high solids contents could be achieved in the past, the slurry had high kinematic viscosities and poor flowability, resulting in slurries that were not evenly distributed on the current collector. Thus, the solids content may be higher, while the corresponding amount of solvent required is lower and furthermore, the desired viscosity levels are achieved for casting high quality thick electrodes without significant mechanical defects on current collectors. Therefore, the use of graphene nanoplatelets allows for a higher initial slurry solids content than with the use of carbon black or carbon fibers or nanotubes, enabling a more stable wet slurry network during coating and decreased drying time.

In certain aspects, the use of the carbon-coated cathode materials can help build up the conductive network in the positive electrode. Therefore, the use of the conductive fillers (e.g., graphene, carbon black) can reduce the amount of materials required, without compromising the final electrode electrical conductivity. Reducing the use of the conductive fillers can further increase the slurry solids content.

In certain aspects, the slurry has a solids content of greater than or equal to about 65 wt. %, optionally greater than or equal to about 70 wt. %, and in certain variations, optionally greater than or equal to about 75 wt. %. Concurrently, the slurry may have a kinematic viscosity of greater than or equal to about 6 Pa·s to less than or equal to about 30 Pa·s at a shear rate of about 20/s at ambient conditions, for example, at 21° C.

Slurry mixing generally includes mixing electroactive material, graphene nanoplatelets, binder, and any additional optional ingredients into a slurry, which can be done under vacuum or ambient conditions. It has been found that a multistep mixing process described herein provided the desired viscosity levels and solids loading for the slurry resulting in high quality thick electrodes. The mixing may be conducted by at least one mixing process selected from the group consisting of: resonance dispersion, sonic dispersion, ultrasonic dispersion, centrifugal or planetary mixing, rotary mixing, ball milling, and combinations thereof. In one variation, centrifugal or planetary mixing is used to mix the components and form a slurry. In certain variations, two different types of mixing processes may be used while preparing the slurry. One of the two different mixing processes may be centrifugal or planetary mixing. Thus, prior to the applying, the slurry may be prepared by first mixing the plurality of graphene nanoplatelets and solvent together to form an admixture. In certain variations, the graphene nanoplatelets may be substantially homogeneously distributed in the solvent.

The mixing speeds during the first mixing process may range from greater than or equal to about 500 to less than or equal to about 10,000 rpm, optionally greater than or equal to about 2,000 to less than or equal to about 5,000 rpm for planetary/centrifugal mixers. The mixing speeds may be greater than or equal to about 30 g to less than or equal to about 100 g (acceleration force) for resonance mixing. The planetary/centrifugal mixing or resonance dispersion may be conducted for a mixing period of about greater than or equal to about 5 minutes to less than or equal to about 5 hours, optionally at greater than or equal to about 1 hour to less than or equal to about 3 hours. In one variation, a centrifugal mixer may be used at 2,000 rpm for a mixing time of about 5 minutes. Ball milling may be conducted at greater than or equal to about 200 rpm to less than or equal to about 500 rpm for a time of greater than or equal to about 5 minutes to less than or equal to about 5 hours. The mixing may have rest period intervals of at least 10 minutes during the mixing.

After forming the admixture of graphene nanoplatelets and solvent, the plurality of positive electroactive material particles and the polymeric binder are introduced into the admixture. A second mixing process may then be conducted to mix in the positive electroactive material particles and the polymeric binder. In certain variations, after the second mixing process, the positive electroactive material and the graphene nanoplatelets may be substantially homogeneously distributed in the solvent and binder. The mixing types, times, and conditions for the second mixing process may be the same as the first mixing process described above. It should be noted that where optional filler components are also present, for example, a second type of electrically conductive particle in addition to the graphene nanoplatelets, they may be mixed into the admixture of solvent and nanoplatelets prior to adding the centrifugal or planetary mixing. The mixing conditions may be similar to those described above for the first mixing step and again, the dispersion of the solid particles may be homogeneously distributed.

In certain aspects, the slurry comprises on a dry basis, where the liquids are excluded, greater than or equal to about 80 weight % to less than or equal to about 98 weight % of the plurality of positive electroactive material particles, greater than or equal to about 0.5 weight % to less than or equal to about 15 weight % of the plurality of graphene nanoplatelets, greater than or equal to about 0.5 weight % to less than or equal to about 20 weight % of the polymeric binder, and solvent. In alternative variations, the slurry further comprises greater than 0 weight % to less than or equal to about 15 weight % of one or more optional filler components. The slurry may have greater than or equal to about 10 weight % to less than or equal to about 36 weight %, optionally greater than or equal to about 25 to 35% by weight solvent, and in certain aspects, optionally greater than or equal to about 30 to 35% by weight solvent, for example, about 35% by weight solvent.

After the slurry is mixed or agitated via the multi-step mixing process described above, the slurry is then thinly applied to a substrate via slot die coating, doctor blade coating, comma bar, spray coating or other known techniques. The substrate can be a removable substrate or alternatively a functional substrate, such as the current collector (such as a metallic grid or mesh layer) attached to one side of the electroactive material layer. The method includes drying the slurry to substantially remove the solvent. By substantially remove the solvent, it is meant that at least 98% of the solvent is removed, optionally greater than 99% of the solvent, optionally greater than 99.5% of the solvent, optionally greater than 99.7% of the solvent, and in certain variations, optionally greater than 99.9% of the solvent is removed from the slurry to form the dried cast solid electroactive layer. The electroactive layer can be dried, for example in an oven or with a heater, to remove the solvent from the electrode. In certain variations, the temperature during the drying process may be greater than or equal to about 35° C., optionally greater than or equal to about 50° C., and in certain variations, greater than or equal to about 75° C., depending on the solvent system used. In certain aspects, the drying process may occur rapidly, for example, in less than or equal to about 10 minutes, optionally less than or equal to about 5 minutes, and optionally less than or equal to about 3 minutes. The drying time may be greater than or equal to about 30 seconds to less than or equal to about 5 minutes, optionally greater than or equal to about 0.5 minutes to less than or equal to about 2 minutes, in one variation.

In one variation, heat or radiation can be applied to facilitate evaporation of the solvent from the cast slurry/electroactive material film, leaving a solid residue. In other variations, the film may be dried at moderate temperatures to form self-supporting films. If the substrate is removable, it is then removed from the electroactive material layer and then further laminated to a current collector. With either type of substrate, the remaining plasticizer may be extracted prior to incorporation into the battery cell.

The electroactive material layer may be further consolidated, where heat and pressure are applied to the film to sinter and calender it. Hence, the method also includes applying pressure to form an electroactive material layer. Electrode pressing (calendering or consolidation) generally includes compressing the electrode to a desired thickness/density. Then, the electroactive material layer (optionally with the current collector) can be pressed using calendering rolls, platens, a press with a die or other suitable processing apparatus to compress the electrodes to a desired thickness. For example, in some embodiments, the electrode active material layer in contact with the current collector foil or other structure can be subjected to a pressure from about 2 to about 10 kg/cm² (kilograms per square centimeter). Prior to applying pressure, the electroactive material layer may have a thickness of greater than or equal to about 200 μm and a porosity level of greater than or equal to about 50% by volume to about 65% by volume, but after the processing may have a thickness of greater than or equal to about 150 μm and a porosity of greater than or equal to 15% by volume to less than or equal to about 50% by volume.

As noted above, the processes provided by certain aspects of the present disclosure provide optimal slurry dispersion and viscosity properties to achieve complex mechanical and electrical networks within the coated electrode for enhanced performance. Thus, the processes of forming the electrodes provided by certain aspects of the present disclosure reduce stress caused by volume shrinkage of the coated battery slurry as it dries, thus avoiding electrode fracture and delamination from the underlying substrate (current collector). In accordance with certain aspects of the present disclosure, the thick electroactive material layers for a positive electrode are substantially free of defects, meaning that the defect is absent to the extent that that undesirable and/or detrimental effects attendant with its presence are avoided. Generally, defects may include relatively large cracks, fractures, uncoated regions, pin holes, and the like. In certain aspects, substantially free of defects means the electroactive layer is free of visible macrocracks, which are generally those cracks observable with the human eye and typically on a scale having a dimension of greater than about 40 to about 50 μm. In certain embodiments, a thick electroactive material layer that is “substantially free” of such defects comprises less than about 5% by weight of the observable macrocracks, more preferably less than about 4% by weight, optionally less than about 3% by weight, optionally less than about 2% by weight, optionally less than about 1% by weight, optionally less than about 0.5% and in certain embodiments comprises 0% by weight of the observable macrocracks.

In other aspects, the applied electroactive material layer may be substantially uniform, meaning that the layer spreads to form a contiguous or continuous surface coating with a minimum of defects (cracking, uncoated regions, pin holes, fractures, and the like). The substantially uniform layer may be have an average thickness that deviates less than or equal to about 25% in thickness from the thinnest to thickest parts of the electroactive material layer, optionally less than or equal to about 20%, optionally less than or equal to about 15%, and in certain aspects, optionally less than or equal to about 10% in thickness from the minimum thickness to maximum thickness of the layer. For example, if the average thickness of the electroactive material layer is 150 μm, a maximum deviation of 20% from the thinnest region to the thickest region would result in a range of 120 μm to 180 μm.

The electrodes described herein can be incorporated into various commercial cell designs. For example, the positive electrodes can be used for prismatic shaped cells, wound cylindrical cells, coin cells, pouch cells or other reasonable cell shapes. The electrochemical cells can comprise a single electrode structure of each polarity or a stacked structure with a plurality of positive electrodes and negative electrodes assembled in parallel and/or series electrical connection(s). In particular, the battery can comprise a stack of alternating positive electrodes and negative electrodes with separators or SSEs between them. Generally, the plurality of electrodes is connected in parallel to increase the current at the voltage established by a pair of a positive electrode and a negative electrode. While the positive electrode active materials can be used in batteries for primary, or single charge use, the resulting batteries generally have desirable cycling properties for secondary battery use over multiple cycling of the cells.

In some embodiments, the positive electrode and negative electrode can be stacked with the separator between them, and the resulting stacked structure can be rolled into a cylindrical or prismatic configuration to form the battery structure. Electrode stacking may include forming, e.g., by a winding machine, layers of positive electrode or cathode, separator, and negative electrode or anode into a cell core. Appropriate electrically conductive tabs can be welded or the like to the current collectors and the resulting jellyroll structure can be placed into a metal canister or polymer package, with the negative tab and positive tab welded to appropriate external contacts. Tab welding generally includes attaching the cell to a cap. Electrolyte is added to the canister, and the canister or package is sealed to complete the battery. Alternatively, the positive electrodes and negative electrodes can be stacked with respective separators between them, and the resulting stack structure placed in a pouch. Cell sealing generally includes sealing with a machine/crimper, aligning the cap with the open end of the case or pouch, and sealing the case or pouch. Electrolyte is added to the case or pouch, which is then sealed to complete the battery. Electrolyte filling generally includes injecting the case or pouch with a liquid electrolyte.

In certain aspects, the present disclosure contemplates a positive electrode for an electrochemical cell that cycles lithium. The positive electrode may include a positive current collector and an electroactive material layer. The electroactive material layer may have a thickness of greater than or equal to about 150 μm and a porosity of greater than or equal to about 15% by volume to less than or equal to about 50% by volume. The electroactive material layer may include a positive electroactive material present at greater than or equal to about 80% by weight of the electroactive material layer. The electroactive material layer also includes a plurality of graphene nanoplatelets having an aspect ratio of greater than or equal to about 20 present at greater than or equal to about 0.5% by weight to less than or equal to about 15% by weight of the electroactive material layer. The electroactive material layer also includes a polymeric binder. As described above, in certain variations, the electroactive material layer is substantially free of macrocracks.

In certain variations, the electroactive material layer comprises greater than or equal to about 80 weight % to less than or equal to about 98 weight % of the plurality of positive electroactive material particles, greater than or equal to about 0.5 weight % to less than or equal to about 15 weight % of the plurality of graphene nanoplatelets, and greater than or equal to about 0.5 weight % to less than or equal to about 20 weight % of the polymeric binder and optionally further comprises less than or equal to about 15 weight % of one or more optional filler components comprising electrically conductive particles.

The electroactive material layer may have a thickness of greater than or equal to about 150 μm to less than or equal to about 2,000 μm.

The positive electroactive material may be selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof. The polymeric binder may be selected from the group consisting of: polyvinylidene difluoride (PVdF), lithium polyacrylate (LiPAA), sodium polyacrylate (NaPAA), polyacrylic acid, polytetrafluoroethylene (PTFE), polyethylene (PE), polyamide, polyimide, and combinations thereof. In certain variations, the positive electroactive material further comprises a coating selected from the group consisting of: a carbon-containing coating, an oxide-containing coating, a fluoride-containing coating, a nitride-containing coating, and combinations thereof.

The electroactive material layer may have a thickness of greater than or equal to about 150 μm to less than or equal to about 2,000 μm.

In one variation, the electroactive material layer may have approximately, 93.5 wt. % LMO active material, about 3.5 wt. % graphene nanoplatelets, about 1 wt. % KS6 graphite as an optional conductive filler particle and further 2 wt. % PVDF binder.

In another variation, the electroactive material layer may have 97 wt. % LMO positive electroactive particles, optionally about 1.5 wt. % graphene nanoplatelets and about 1.5 wt. % of a PVDF and PAA binder.

In another variation, the electroactive material layer may have 97 wt. % carbon-coated LMO positive electroactive particles, optionally less than or equal to about 1 wt. % graphene nanoplatelets and about 1.5 wt. % of a PVDF and/or PAA binder.

A lithium-ion battery or electrochemical cell incorporating an inventive thick positive electrode prepared in accordance with certain aspects of the present disclosure, provides advantageously liquid phase lithium ion transfer kinetics, while providing homogenous and/or tailored structural integrity of thick electrodes and minimizing deterioration of the life and power/fast charging performance.

In certain aspects, a lithium-ion battery incorporating an inventive thick positive electrode prepared by the above-described methods can substantially maintain charge capacity (e.g., performs within a preselected range or other targeted high capacity use) for at least about 1,000 hours of battery operation, optionally greater than or equal to about 1,500 hours of battery operation, optionally greater than or equal to about 2,500 hours or longer of battery operation, and in certain aspects, optionally greater than or equal to about 5,000 hours or longer (active cycling).

In certain aspects, the lithium-ion battery incorporating an inventive thick positive electrode prepared in accordance with certain methods of the present disclosure maintains charge capacity and thus is capable of operating within 20% of target charge capacity for a duration of greater than or equal to about 2 years (including storage at ambient conditions and active cycling time), optionally greater than or equal to about 3 years, optionally greater than or equal to about 4 years, optionally greater than or equal to about 5 years, optionally greater than or equal to about 6 years, optionally greater than or equal to about 7 years, optionally greater than or equal to about 8 years, optionally greater than or equal to about 9 years, and in certain aspects, optionally greater than or equal to about 10 years.

In other aspects, the lithium-ion battery incorporating an inventive thick positive electrode prepared in accordance with certain methods of the present disclosure is capable of operating at less than or equal to about 30% change in a preselected target charge capacity (thus having a minimal charge capacity fade), optionally at less than or equal to about 20%, optionally at less than or equal to about 15%, optionally at less than or equal to about 10%, and in certain variations optionally at less than or equal to about 5% change in charge capacity for a duration of at least about 100 deep discharge cycles, optionally at least about 200 deep discharge cycles, optionally at least about 500 deep discharge cycles, optionally at least about 1,000 deep discharge cycles.

Stated in another way, in certain aspects, a lithium-ion battery or electrochemical cell incorporating an inventive thick positive electrode prepared in accordance with certain aspects of the present disclosure substantially maintains charge capacity and is capable of operation for at least about 1,000 deep discharge cycles, optionally greater than or equal to about 2,000 deep discharge cycles, optionally greater than or equal to about 3,000 deep discharge cycles, optionally greater than or equal to about 4,000 deep discharge cycles, and in certain variations, optionally greater than or equal to about 5,000 deep discharge cycles.

### EXAMPLES

### Example 1

Examples of electrode formulations. Comparative examples 1 and 3 and inventive examples 2 and 4-6 are prepared in accordance with certain aspects of the present disclosure were formed with amounts of the electroactive layer components indicated in Table 1. The examples prepared in accordance with certain aspects of the present disclosure involved first mixing a solvent N-methyl-2-pyrrolidone (NMP) with multilayer graphene nanoplatelets (particle diameter ranges may be less than 2 μm up to 25 μm, with surface area of about 50-750 m²/g commercially available from XGSciences). The mixing is conducted in a centrifugal mixer for about 10 to about 30 minutes at 2000 rpm. After the admixture of graphene nanoplatelets and solvent is formed, any optional fillers, such as electrically conductive particles like carbon black may be mixed in. Where present, the mixing of the optional filler particles is conducted by a centrifugal mixer for about 5 to 20 minutes at 2,000 rpm. Finally, the electroactive LMO particles are commercially available from Borman Specialty Materials with powder size distributions as follows, D99 of about 15 to about 40 μm, a D50 of about 5 μm to about 15 μm and a D10 of about 1 μm to about 10 The polymeric binder is PVDF, which can be added to the admixture and then mixed in a final mixing process involving a centrifugal mixer for about 5 to about 20 minutes at 2,000 rpm to create a slurry. The calculated solids levels, viscosity levels of the respective slurries at different shear rates (20 l/s, 50 l/s, and 100 l/s) at ambient conditions (e.g., approximately 21° C.) are provided in Table 1.

TABLE 1

| | | Viscosity | Viscosity | Viscosity | |
|---|---|---|---|---|---|
| | | Pa · s | Pa · s | Pa · s | |
| | Solids | (Shear rate - | (Shear rate - | (Shear rate - | |
| Filler and Binder | (Calc.) | 20 1/s) | 50 1/s) | 100 1/s) | Dispersant |
| Comparative Example 1 - | 64% | 3.298 | 1.830 | 1.240 | Solvent |
| 1.5% Carbon Black (CB) | | | | | |
| with PVDF | | | | | |
| Inventive Example 2 - | 64% | 0.945 | 0.835 | 0.744 | Solvent |
| 1.5% Graphene (GNP) | | | | | |
| with PVDF | | | | | |
| Comparative Example 3 - | 69% | 8.302 | 4.817 | 3.544 | Solvent |
| 1.5% Carbon Black (CB) | | | | | |
| with PVDF | | | | | |
| Inventive Example 4 - | 69% | 4.281 | 2.901 | 2.249 | Solvent |
| 1.5% Graphene (GNP) | | | | | |
| with PVDF | | | | | |
| Inventive Example 5 - | 69% | 6.055 | 3.552 | 2.556 | Solvent |
| 0.75% Graphene (GNP) | | | | | |
| and 0.75% Carbon Black | | | | | |
| (CB) with PVDF | | | | | |
| Inventive Example 6 - | 69% | 2.687 | 1.781 | 1.378 | Solvent |
| 1.5% Graphene (GNP) | | | | | |
| with PAA | | | | | |

The use of graphene nano-platelets (GNP) in Inventive Examples 2 and 4-6 allows for a higher initial slurry solids content than with the use of carbon black (CB) alone (Comparative Examples 1 and 3) enabling a more stable wet slurry network during coating and decreased electrode drying time. Viscosity levels for the same solids content as standard carbon black (CB) is lower with GNP, which allows for easier processing. Furthermore, it was unexpectedly discovered that when PAA is used as the binder, the solids content can be further increased while providing a high quality thick electrode.

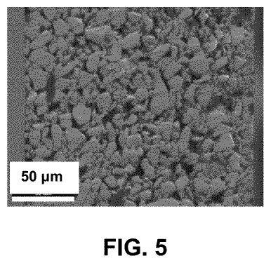

The slurry is then applied to an aluminum current collector and then dried at 70° C. to remove all solvent and pressed down to 30-40% porosity. A cross-section of a positive electrode having a thickness of approximately 200 μm is shown in the image in FIG. 5, where a high quality dried solid electrode is formed with no visible cracks (e.g., macrocracks) can be observed.

### Example 2

Electrode Life Testing.

Comparative Example 6 and inventive Examples 7-8 are prepared in accordance with certain aspects of the present disclosure. Comparative Example 6 comprises LMO electroactive particles at about 97 wt. % solids like those described above in Example 1, carbon black “Super P” particles commercially available from TimCal at about 1.5 wt. % solids, is N-methyl-2-pyrrolidone (NMP) from VWR solvent present at about 36 wt. % by total blend. The loading of LMO in the electrode is about 44.5 mg/cm².

Inventive Example 7 comprises LMO electroactive particles at about 97 wt. % solids, graphene nanoplatelets at about 1.2 wt. % solids, carbon nanotubes sold by Tuball at about 0.3 wt. % solids, NMP solvent at about 52 wt. % by total blend. The loading of LMO in the electrode is about 44.5 mg/cm².

Inventive Example 8 comprises LMO electroactive particles at about 97 wt. %, graphene nanoplatelets at about 0.75 wt. %, carbon black “Super P” particles at about 0.75 wt. %, NMP solvent at about 31 wt. % by total blend. The loading of LMO in the electrode is about 40.5 mg/cm².

The electroactive materials were processed by the same basic processes as described in Example 1 above to form the test electrodes. For electrodes containing carbon nanotubes, there were higher initial porosity values ranging from 60-70% porosity.

The positive LMO-containing electrodes (Comparative Example 6 and Inventive Examples 7 and 8) were incorporated into full electrochemical cells with graphite as the negative electrode material. The operational windows are 4.2V-3.2V, formation of 2 Cycles at C/20, and life test was conducted at a rate of C/5. After 25 cycles, it was determined that the electrochemical cell performance of Inventive Examples 7 and 8 is similar to that of Comparative Example 6, for example, within 1-3% of mAh/cm². Example 2 thus shows that incorporation of graphene nanoplatelets provides substantial benefits to the processing and coating processes and thus the ability to form high quality thick electrodes, without degrading performance of an electrochemical cell into which the positive electrode is incorporated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a positive electrode for an electrochemical cell that cycles lithium, the method comprising:
applying a slurry to a current collector, wherein the slurry comprises a plurality of positive electroactive material particles, a plurality of graphene nanoplatelets, a polymeric binder, and solvent, wherein the slurry has a solids content of greater than or equal to about 65% by weight, and a kinematic viscosity of greater than or equal to about 6 Pa·s to less than or equal to about 30 Pa·s at a shear rate of about 20/s; and
drying the slurry to substantially remove the solvent and applying pressure to form an electroactive material layer having a thickness of greater than or equal to about 150 μm and a porosity of greater than or equal to 15% by volume to less than or equal to about 50% by volume, wherein the electroactive material layer is substantially free of macrocracks.

2. The method of claim 1, wherein the solids content of the slurry is greater than or equal to about 75% by weight.

3. The method of claim 1, wherein the drying occurs at less than or equal to about 10 minutes.

4. The method of claim 1, wherein applying pressure is a consolidating or calendering process where the current collector and the electroactive material layer is passed between rollers or platens.

5. The method of claim 1, wherein the slurry has greater than or equal to about 30 weight % to less than or equal to about 35 weight % by weight of solvent.

6. The method of claim 1, wherein prior to the applying, the slurry is prepared by first mixing the plurality of graphene nanoplatelets and solvent together to form an admixture, followed by mixing the plurality of positive electroactive material particles and the polymeric binder into the admixture.

7. The method of claim 1, wherein the mixing comprises at least one mixing process selected from the group consisting of: resonance dispersion, sonic dispersion, ultrasonic dispersion, centrifugal or planetary mixing, rotary mixing, ball milling, and combinations thereof.

8. The method of claim 1, wherein the slurry comprises greater than or equal to about 80 weight % to less than or equal to about 98 weight % on a dry basis of the plurality of positive electroactive material particles, greater than or equal to about 0.5 weight % to less than or equal to about 15 weight % on a dry basis of the plurality of graphene nanoplatelets, greater than or equal to about 0.5 weight % to less than or equal to about 20 weight % on a dry basis of the polymeric binder and the slurry optionally further comprises greater than 0 weight % to less than or equal to about 15 weight % on a dry basis of one or more optional filler components.

9. The method of claim 1, wherein the polymeric binder is selected from the group consisting of: polyvinylidene difluoride (PVdF), lithium polyacrylate (LiPAA), sodium polyacrylate (NaPAA), polyacrylic acid, polytetrafluoroethylene (PTFE), polyethylene (PE), polyamide, polyimide, and combinations thereof.

10. A method of making a positive electrode for an electrochemical cell that cycles lithium, the method comprising:
applying a slurry to a current collector, wherein the slurry comprises a plurality of positive electroactive material particles selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof present at greater than or equal to about 80% by weight of the total solids in the slurry, a plurality of graphene nanoplatelets present at greater than or equal to about 0.5% by weight to less than or equal to about 15% by weight of the total solids in the slurry, a polymeric binder present at greater than or equal to about 0.5% by weight to less than or equal to about 20% by weight of the total solids in the slurry, and solvent, wherein the slurry has a solids content of greater than or equal to about 70% by weight, and a kinematic viscosity of greater than or equal to about 6 Pa·s to less than or equal to about 30 Pa·s at a shear rate of about 20/s; and
drying the slurry to substantially remove the solvent and applying pressure to form an electroactive material layer having a thickness of greater than or equal to about 150 μm and a porosity of greater than or equal to about 15% by volume to less than or equal to about 50% by volume, wherein the electroactive material layer is substantially free of macrocracks.

11. The method of claim 10, wherein the drying occurs at less than or equal to about 10 minutes and the applying pressure is a consolidating or calendering process where the current collector and the electroactive material layer are passed between rollers or platens.

12. The method of claim 10, wherein prior to the applying, the slurry is prepared by first mixing the plurality of graphene nanoplatelets and solvent together to form an admixture, followed by mixing the plurality of positive electroactive material particles and the polymeric binder into the admixture.

13. The method of claim 10, wherein the mixing comprises at least one mixing process selected from the group consisting of: resonance dispersion, sonic dispersion, ultrasonic dispersion, centrifugal or planetary mixing, rotary mixing, ball milling, and combinations thereof.

14. The method of claim 10, wherein the slurry further comprises greater than 0 weight % to less than or equal to about 15 weight % of one or more optional filler components.

15. A positive electrode for an electrochemical cell that cycles lithium, comprising:
a current collector;
an electroactive material layer having a thickness of greater than or equal to about 150 μm, a porosity of greater than or equal to about 15% by volume to less than or equal to about 50% by volume and comprising:
a positive electroactive material present at greater than or equal to about 80% by weight of the electroactive material layer;
a plurality of graphene nanoplatelets having an aspect ratio of greater than or equal to about 20 present at greater than or equal to about 0.5% by weight to less than or equal to about 15% by weight of the electroactive material layer; and
a polymeric binder, wherein the electroactive material layer is substantially free of macrocracks.

16. The positive electrode of claim 15, wherein the electroactive material layer comprises greater than or equal to about 80 weight % to less than or equal to about 98 weight % of the plurality of positive electroactive material particles, greater than or equal to about 0.5 weight % to less than or equal to about 15 weight % of the plurality of graphene nanoplatelets, and greater than or equal to about 0.5 weight % to less than or equal to about 20 weight % of the polymeric binder and optionally further comprises less than or equal to about 15 weight % of one or more optional filler components comprising electrically conductive particles.

17. The positive electrode of claim 15, wherein the electroactive material layer has a thickness of greater than or equal to about 175 μm to less than or equal to about 2,000 μm.

18. The positive electrode of claim 15, wherein the positive electroactive material is selected from the group consisting of: lithium manganese oxide, lithium manganese nickel oxide, lithium nickel manganese cobalt oxide, lithium nickel manganese cobalt aluminum oxide, lithium iron phosphate, lithium manganese iron phosphate, lithium silicate, and combinations thereof.

19. The positive electrode of claim 15, wherein the positive electroactive material comprises a coating selected from the group consisting of: a carbon-containing coating, an oxide-containing coating, a fluoride-containing coating, a nitride-containing coating, and combinations thereof.

20. The positive electrode of claim 15, wherein the polymeric binder is selected from the group consisting of: polyvinylidene difluoride (PVdF), lithium polyacrylate (LiPAA), sodium polyacrylate (NaPAA), polyacrylic acid, polytetrafluoroethylene (PTFE), polyethylene (PE), polyamide, polyimide, and combinations thereof.
